(19) United States
(12) Patent Application Publication
(10) Pub. No.: US 2016/0304407 A1
(43) Pub. Date: Oct. 20, 2016

(54) Soybean Starter Fertilizer for In-Furrow Application

(71) Applicant: Nachurs Alpine Solutions, Corp., Marion, OH (US)

(72) Inventor: Gregory Bame, Marion, OH (US)

(21) Appl. No.: 14/947,183

(22) Filed: Nov. 20, 2015

Related U.S. Application Data
(60) Provisional application No. 62/147,454, filed on Apr. 14, 2015.

(51) Int. Cl. C05B 7/00

(52) U.S. Cl. CPC C05B 7/00

(57) ABSTRACT

The present development is a composition for a liquid soybean starter fertilizer that can be applied as an in-furrow application. The fertilizer composition includes potassium hydroxide and a potassium carboxylate, and the concentration of potassium oxide (K₂O) derived from potassium hydroxide relative to the concentration of K₂O derived from the potassium carboxylate source is preferably less than 1.2.

### CROSS-REFERENCE TO PRIOR APPLICATIONS

The present application claims priority to U.S. Patent Application Ser. No. 62/147,454 filed Apr. 14, 2015, currently pending, which is incorporated by reference in its entirety.

### FIELD OF THE INVENTION

The invention relates to a plant fertilizer comprising nitrogen, phosphorus, and potassium, wherein the product is specifically formulated for in-furrow application to stimulate soybean seeds during the planting process.

### BACKGROUND OF THE INVENTION

In order to maintain healthy growth, plants must extract a variety of nutrients from the soil in which they grow. However, many soils are deficient in the nutrients that are needed, or the soils contain them only in forms which cannot be readily taken up by plants. To counteract these deficiencies, commercial fertilizing products containing select nutrients are commonly applied to soils in order to improve growth rates and yields obtained from crop plants. For example, phosphates may be added to soil to counteract a lack of available phosphorus.

Fertilizers may be characterized by how they are utilized in horticulture. A “starter fertilizer” is typically used to promote the growth of newly planted crops, particularly newly germinated seeds. Starter fertilizers may be applied in bands or in-furrow. Banding fertilizer mixes the fertilizer with small portions of soil rather than placing the fertilizer in direct contact with the seed. However, banding can be expensive, can result in inconsistent soil fertility, and may create soil disturbance that can adversely affect seed placement. Alternatively, in-furrow treatment places the fertilizer directly with the seed during planting. This eliminates the negative effects seen with banding, but can be stressful to the seed because seeds tend to be sensitive to fertilizer salts.

Soybeans provide oil and high-protein meal for human and animal consumption. From a production perspective, soybeans are relatively easy to grow and are subject to relatively few insect pests compared to other crops. However, soybeans are a salt-sensitive seed, and academic studies commonly advise against seed-placed fertilizers because of potential decreased germination.

In 2013, Applicant conducted a Soy Booster field study that used Nachurs Alpine HKW6 fertilizer (liquid 2-6-16 N-P-K fertilizer) in combination with FMC Capture LFR (Liquid Fertilizer Ready) for in-furrow application with soybean seed. In 91 plots across 16 states, growers reported a 72% positive yield response for soybeans by using the combination. However, the HKW6 fertilizer did not demonstrate long-term storage stability. Thus, it would be beneficial to have a liquid fertilizer that is safe for in-furrow application with soybeans and effective for stimulating soybean growth, but that is also storage-stable.

### SUMMARY OF THE PRESENT INVENTION

The present development is a composition for a soybean starter fertilizer that can be applied as an in-furrow application. The fertilizer of the present invention comprises water, soluble nitrogen, a potassium phosphate, potassium hydroxide and a potassium carboxylate source, wherein the concentration of potassium oxide (K₂O) derived from potassium hydroxide relative to the concentration of K₂O derived from the potassium carboxylate source is preferably less than 1.2 and the pH is between about 7.0 and 9.0. The fertilizer of the present invention is preferably a 2-6-16 N-P-K blend.

### DETAILED DESCRIPTION OF THE PRESENT DEVELOPMENT

The present development is a composition for a liquid soybean starter fertilizer that is intended to be applied in-furrow with the soybean seed. The fertilizer of the present invention comprises water, soluble nitrogen, a potassium phosphate, potassium hydroxide and a potassium carboxylate source. Optionally, the fertilizer may further comprise a sulfur source, a zinc source, acetic acid, a microbial inoculant, or a combination thereof.

The recommended soluble nitrogen source is urea, ammonia, or a combination thereof. When urea is used in combination with ammonia, it is recommended that the amount of nitrogen derived from the urea relative to the amount of nitrogen derived from the ammonia ranges from 1:1 to 4:1. In a first exemplary embodiment, aqueous ammonia is used in combination with urea, the weight ratio of aqueous ammonia nitrogen to urea nitrogen is between about 1:6 to about 1:2, and the ammonia-urea combination comprises from about 1.0 wt % to about 12.0 wt % of the composition. In a second exemplary embodiment, the soluble nitrogen source is urea and the urea comprises from about 1.0 wt % to about 12.0 wt % of the composition. Optionally, other sources of soluble nitrogen as are known in the art may be used, such as nitrate, ammonia, ammonium salts, amino acids, urea, fish meal or extract, compost extract, kelp extract, shrimp extract, shellfish extract, and combinations thereof. The concentration of the soluble nitrogen source will vary depending on the source selected, but the resulting available nitrogen in the final composition should be up to about 10 wt %, and is more preferably from about 0.5 wt % to about 5.0 wt %, and is most preferably from about 1.5 wt % to about 2.5 wt %.

The phosphate is derived from potassium phosphate, monopotassium phosphate, dipotassium phosphate, potassium phosphate generated by reaction of potassium hydroxide with phosphoric acid, tetrapotassium pyrophosphate, orthophosphate, ammonium phosphate, and combinations thereof. Preferably, the phosphate source further includes at least one source of phosphoric acid. In a preferred embodiment, the phosphate source is potassium phosphate generated by reaction of potassium hydroxide with phosphoric acid. The resulting available phosphorus in the final composition should be from about 4.0 wt % to about 7.0 wt %.

The potassium is derived from potassium hydroxide combined with a potassium carboxylate. In a preferred embodiment, the potassium carboxylate is selected from the group consisting of potassium acetate, potassium formate, potassium citrate, potassium succinate, potassium propionate, animal manure, and combinations thereof. In a more preferred embodiment, potassium hydroxide is combined with potassium acetate.

To produce a satisfactory in-furrow composition, the potassium hydroxide (KOH), whether added to react with phosphoric acid or added as a potassium source, and organic salts of potassium (KO₂R) should be combined in the composition such that the concentration of potassium oxide derived from the potassium hydroxide relative to the concentration of potassium oxide derived from the potassium carboxylate is less than about 1.2, or [K₂O derived from KOH]/[K₂O derived from KO₂R]<1.2. Preferably, the [K₂O derived from KOH]/[K₂O derived from KO₂R] is maintained at from about 0.4 to about 1.2, and most preferably from about 0.55 to about 1.00. If the potassium carboxylate is potassium acetate, the preferred [K₂O derived from KOH]/[K₂O derived from KO₂R] is from about 0.55 to about 0.80.

The resulting available potassium in the final composition should be from about 10 wt % to about 20 wt %, and is more preferably from about 14 wt % to about 18 wt %, and is most preferably about 16 wt %. Further, the potassium source selected and the amount added to the composition should provide a buffering function to the composition and maintain the pH between 5.5 and 9.0, and more preferably between 7.0 to 8.5, and most preferably between 7.7 and 8.5.

Optionally, the fertilizer may further comprise up to 25 wt % of a sulfur source, a zinc source, acetic acid, a microbial inoculant or a combination thereof. The sulfur is preferably provided as ammonium thiosulfate, although other sulfur sources as are known in the art may be used, the zinc is preferably added as zinc ethylenediaminetetraacetic acid (ZnEDTA), and the acetic acid is preferably a glacial acetic acid. The microbial inoculant may comprise any of a number of organisms or beneficial microbes, as are known in the art for fertilization of soybean seeds.

The composition also contemplates the addition of other supplemental sources of nutrients, including but not limited to ammonium nitrate, calcium, magnesium, sodium, and other micronutrients, such as iron, manganese, copper, zinc, molybdenum, boron and chloride.

Water is added to balance the composition.

In a preferred embodiment, the composition is prepared by slowly combining water and phosphoric acid in a mix tank at ambient temperature with mixing. After about 15% of the total composition phosphoric acid is added, the potassium source is added to the mix tank as the remaining phosphoric acid and water are added. After the potassium source is added, additional water is added to the mixture while continuing to add the remaining phosphoric acid. Once all the water and phosphoric acid has been added, the nitrogen source is added to the mixture, optionally using agitation. The resulting composition is pumped through a filter and heat exchanger, reducing the temperature below 125° F. Potassium acetate is then added and blended into the mixture. The composition can then be pumped into a storage tank, packaged and distributed.

The liquid soybean starter fertilizer of the present application demonstrates improved storage stability over liquid fertilizer compositions of the prior art. For example, a liquid 2-6-16 fertilizer made from urea, potassium phosphate generated by reaction of potassium hydroxide with phosphoric acid, potassium hydroxide and potassium acetate wherein the concentration of potassium oxide derived from potassium hydroxide relative to the concentration of potassium oxide derived from the potassium acetate is from 0.55 to 0.65 and the pH is maintained between 7.7 and 8.5 is storage stable for approximately 24 months compared to a liquid 2-6-16 fertilizer made from urea, orthophosphate, potassium hydroxide and potassium acetate wherein the concentration of potassium oxide derived from potassium hydroxide relative to the concentration of potassium oxide derived from the potassium acetate is from 0.60 to 1.00 and the pH is maintained between 7.0-7.6, which is storage stable for approximately 12 months.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. The term “ambient temperature” as used herein refers to an environmental temperature of from about 0° F. to about 120° F., inclusive.

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise.

It is understood that, in light of a reading of the foregoing description, those with ordinary skill in the art will be able to make changes and modifications to the present invention without departing from the spirit or scope of the invention, as defined herein. For example, those skilled in the art may substitute materials supplied by different manufacturers than specified herein without altering the scope of the present invention.

What is claimed is:

1. A composition for a soybean starter fertilizer comprising water, soluble nitrogen, a potassium carboxylate, potassium hydroxide and potassium phosphate, and wherein potassium oxide (K₂O) is derived from the potassium hydroxide and potassium oxide is derived from the potassium carboxylate, and wherein the concentration of potassium oxide derived from the potassium hydroxide relative to the concentration of potassium oxide derived from the potassium carboxylate is less than 1.2 and the composition pH is from about 5.5 to 9.0.

2. The composition of claim 1 wherein the concentration of potassium oxide derived from the potassium hydroxide relative to the concentration of potassium oxide derived from the potassium carboxylate is from 0.5 to 1.0.

3. The composition of claim 1 wherein the pH of the composition is maintained at from about 7.7 to about 8.5.

4. The composition of claim 1 wherein the potassium carboxylate is selected from the group consisting of potassium acetate, potassium formate, potassium citrate, potassium succinate, potassium propionate, animal manure, and combinations thereof.

5. The composition of claim 4 wherein the potassium carboxylate is a potassium acetate.

6. The composition of claim 5 wherein the concentration of potassium oxide derived from potassium hydroxide relative to the concentration of potassium oxide derived from the potassium acetate is from 0.55 to 0.80.

7. The composition of claim 1 wherein the soluble nitrogen source is selected from the group consisting of nitrate, ammonia, ammonium salts, amino acids, urea, fish meal or extract, compost extract, kelp extract, shrimp extract, shellfish extract, and combinations thereof.

8. The composition of claim 7 wherein the soluble nitrogen source is urea, ammonia, or a combination thereof.

9. The composition of claim 7 wherein the soluble nitrogen source is urea.

10. The composition of claim 1 wherein the available nitrogen concentration is from 1.0 wt % to 12.0 wt %.

11. The composition of claim 10 wherein the available nitrogen concentration is from 0.5 wt % to 5.0 wt %.

12. The composition of claim 1 wherein the phosphate is derived from the group consisting of potassium phosphate, monopotassium phosphate, dipotassium phosphate, potassium phosphate generated by reaction of potassium hydroxide with phosphoric acid, tetrapotassium pyrophosphate, orthophosphate, ammonium phosphate, and combinations thereof.

13. The composition of claim 12 wherein the available phosphorus concentration is from 4.0 wt % to 7.0 wt %.

14. The composition of claim 1 further comprising a sulfur source, a zinc source, acetic acid, a microbial inoculant, or any combination thereof.

15. A composition for a soybean starter fertilizer consisting essentially of:
a. water;
b. soluble nitrogen;
c. a potassium carboxylate;
d. potassium hydroxide;
e. potassium phosphate; and,
f. a supplemental additive selected from the group consisting of a sulfur source, a zinc source, acetic acid, a microbial inoculant, or a combination thereof;
and wherein potassium oxide is derived from the potassium hydroxide and potassium oxide is derived from the potassium carboxylate, and wherein the concentration of potassium oxide derived from the potassium hydroxide relative to the concentration of potassium oxide derived from the potassium carboxylate is less than 1.2.

16. The composition of claim 15 wherein the potassium carboxylate is selected from the group consisting of potassium acetate, potassium formate, potassium citrate, potassium succinate, potassium propionate, animal manure, and combinations thereof.

17. The composition of claim 15 wherein the soluble nitrogen source is selected from the group consisting of nitrate, ammonia, ammonium salts, amino acids, urea, fish meal or extract, compost extract, kelp extract, shrimp extract, shellfish extract, and combinations thereof.

18. The composition of claim 15 wherein the phosphate is derived from the group consisting of potassium phosphate, monopotassium phosphate, dipotassium phosphate, potassium phosphate generated by reaction of potassium hydroxide with phosphoric acid, tetrapotassium pyrophosphate, orthophosphate, ammonium phosphate, and combinations thereof.

19. The composition of claim 15 wherein the concentration of the supplemental additive ranges from 0 wt % to 25 wt %, and the sulfur source is ammonium thiosulfate, the zinc source is zinc ethylenediaminetetraacetic acid (ZnEDTA), and the acetic acid is a glacial acetic acid.

20. The composition of claim 15 wherein the potassium carboxylate is a potassium acetate, and the concentration of potassium oxide derived from potassium hydroxide relative to the concentration of potassium oxide derived from the potassium acetate is from 0.55 to 0.80.
